(19) United States
(12) Patent Application Publication
(10) Pub. No.: US 2012/0221960 A1
(43) Pub. Date: Aug. 30, 2012

(54) COLLABORATIVE WORKSPACE VIEWING FOR PORTABLE ELECTRONIC DEVICES

(76) Inventors: Ian N. Robinson, Pebble Beach, CA (US); April Slayden Mitchell, San Jose, CA (US); Daniel George Gelb, Redwood City, CA (US)

(21) Appl. No.: 13/037,289

(22) Filed: Feb. 28, 2011

(51) Int. Cl. G06F 3/01; G06F 15/16

(52) U.S. Cl. 715/751

(57) ABSTRACT

Embodiments of the present invention disclose a system and method for providing collaborative workspace viewing for portable electronic devices. According to one embodiment, a first portable electronic device operated by a first user and a second portable electronic device operating by a second user are connected over a network. Furthermore, an image captured by an imaging sensor associated with either the first portable device or the second portable electronic device is displayed on a user interface of both the first portable electronic device and the second portable electronic device. In addition, gesture input received from both the first user and the second user and relating to the captured image is displayed concurrently on both the first portable electronic device and the second portable electronic device.

### BACKGROUND

The emergence and popularity of mobile computing has made portable electronic devices, due to theft compact design and light weight, a staple in today's marketplace. In addition, many of these portable electronic devices include a touchscreen display device configured to detect the location and presence of a user's desired touch input. For example, a user's finger or a passive object, such as a stylus, may come into physical contact with the touchscreen display so as to register as an input at said location. Furthermore, some portable electronic devices include front and rear-facing cameras for facilitating mobile video conferencing between devices. However, sharing and interacting with media while video conferencing still poses a problem for such feature-rich portable electronic devices.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIGS. 1A and 1B are three-dimensional perspective views of an operating environment utilizing a collaborative workspace viewing system according to an example of the present invention.

FIG. 2 is a simplified block diagram of a system implementing collaborative workspace viewing for multiple portable electronic devices according to an example of the present invention.

FIGS. 3A and 3B are simplified illustrations of the user interface implementing collaborative workspace viewing according to an example of the present invention.

FIG. 4 is a simplified illustration of data transfer processing using the collaborative workspace viewing method in accordance with an example of the present invention.

FIG. 5 is a simplified flow chart of the processing steps for providing collaborative workspace viewing according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

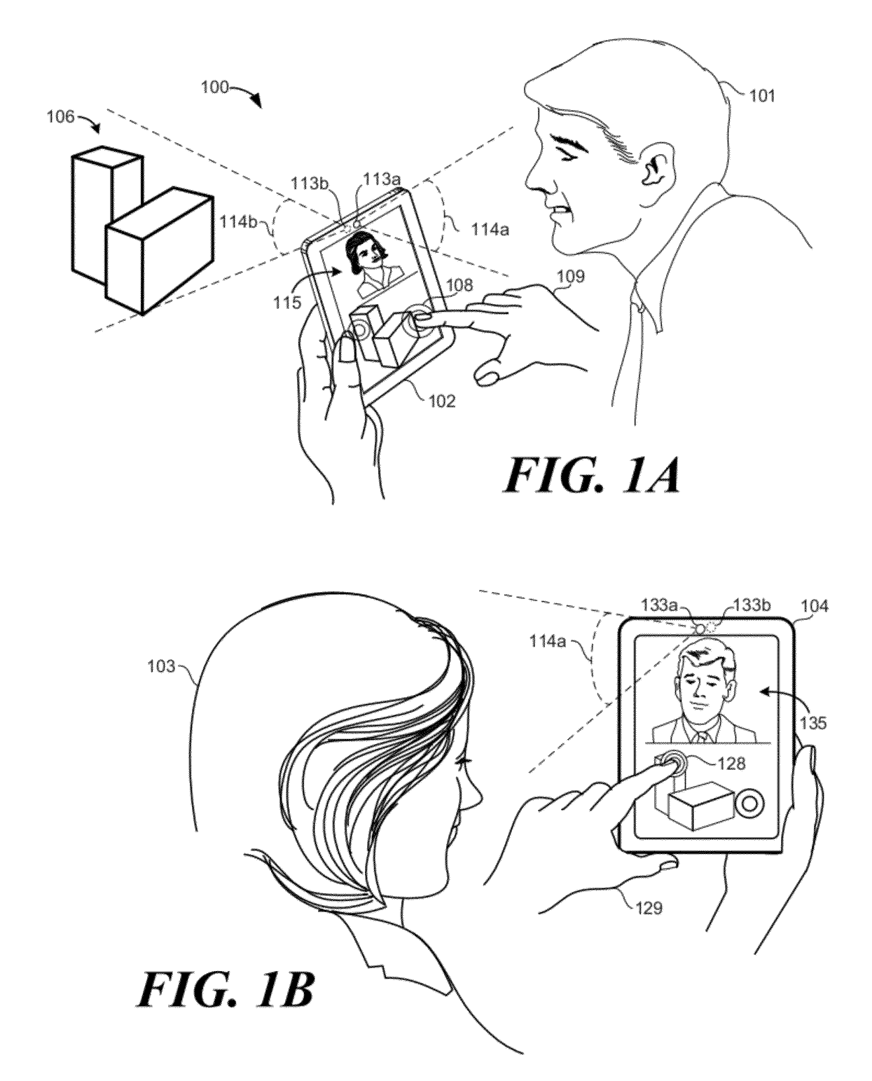

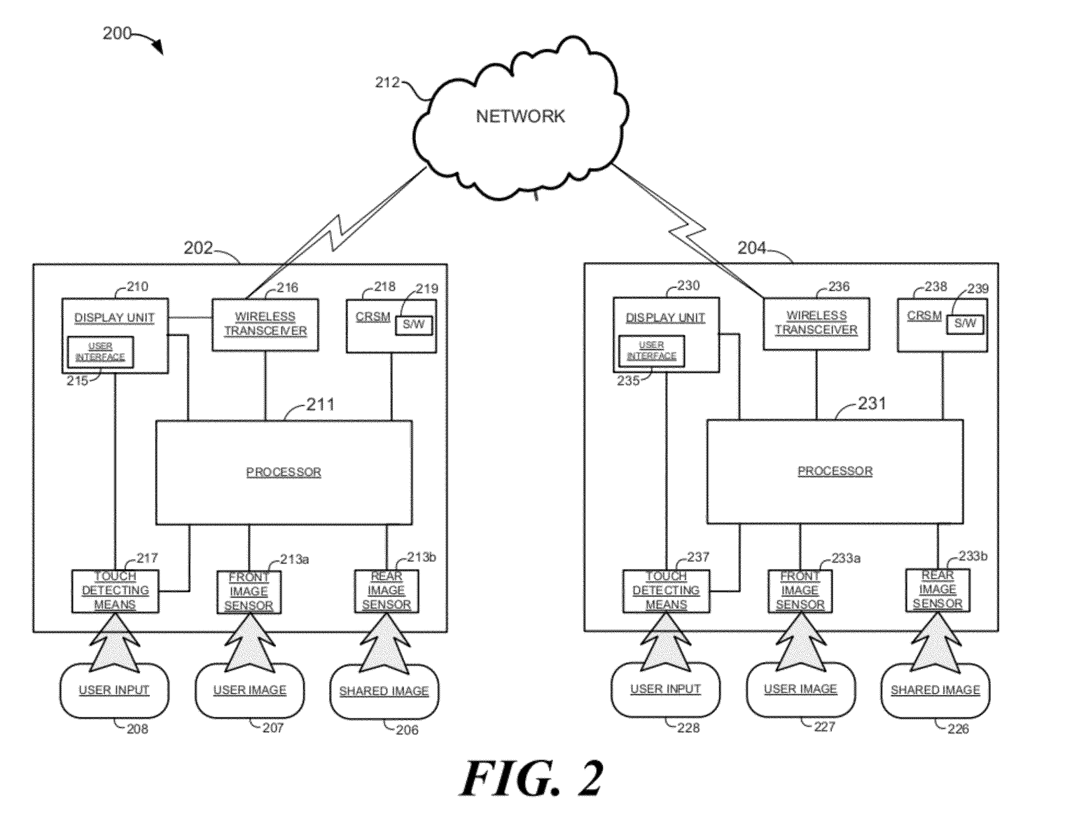

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Prior software solutions allow conference calling while sharing documents (e.g. desktop sharing, or Microsoft PowerPoint slides). In this method, the presenter may make markings or comments on the shared media, but other viewers or users are unable to perform similar tasks unless the presenter transfers the requisite rights over to the other presenters. In addition, this method does not support videoconferencing on a portable electronic device, nor sharing live or prerecorded video from a portable electronic device. Other solutions to the aforementioned problem allow for switching between front and rear facing cameras during a virtual conference, but doesn't show the two views together, nor allow both parties to interact with shared media captured from one of the devices.

Examples of the present invention help provide collaborative workspace viewing between portable electronic devices. According to one example, each portable electronic device includes both front and rear-facing cameras in addition to a touch-sensitive display. Furthermore, each portable electronic device is configured to display an image of the remote user (i.e. image captured by the front-facing camera) in combination with an image from one of the rear-facing cameras. The touch-sensitive display allows either operating user to point at the shared image and have the location of that gesture be indicated on the display of the other participating user.

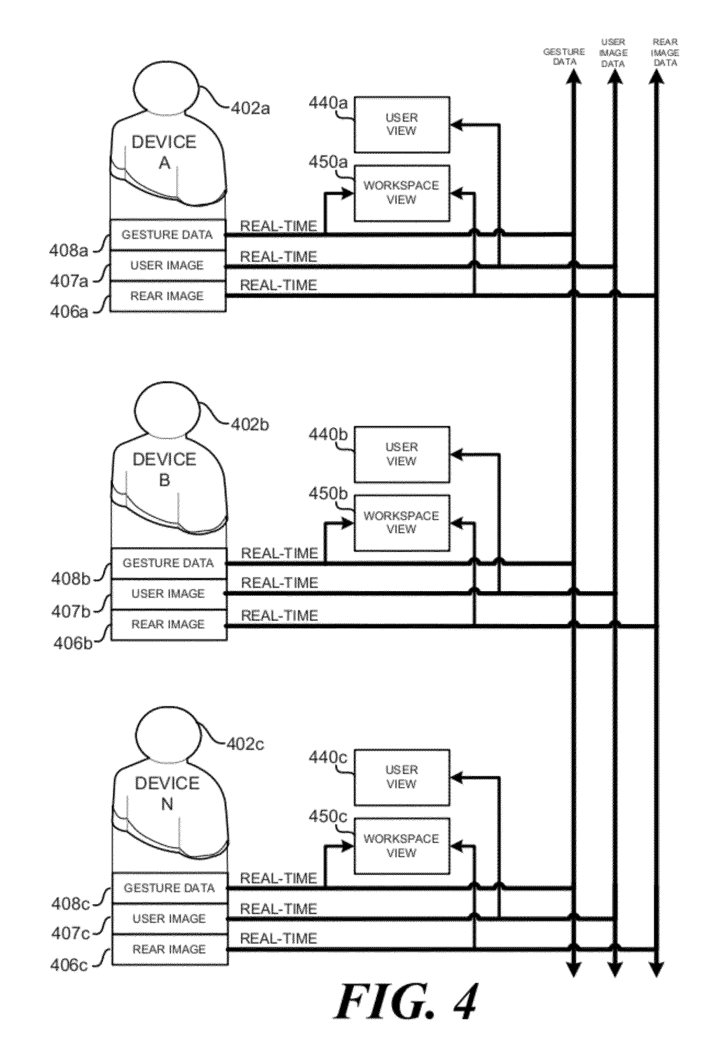

Referring now in more detail to the drawings in which like numerals identify corresponding parts throughout the views, FIGS. 1A and 1B are three-dimensional perspective views of an operating environment utilizing the collaborative workspace viewing system according to an example of the present invention. As shown in the example of FIG. 1A, the system 100 includes a host user 101 operating a host portable electronic device 102. The host portable electronic device 102 includes a front-facing image sensor 113a configured to capture a view (e.g. live video or image) 114a of the operating user 101, in addition to a rear-facing image sensor 113b configured to capture a view (e.g., live video or image) 114b of a target object or scene 106 to share with remote operating users. The host portable electronic device 102 also includes a touch-sensitive display and a graphical user interface 115 for facilitating gesture input 108 from a user's body part 109 (e.g. finger or hand). According to one example, the host user 101 presents the operating user that shares a workspace view with other remote users as will be described in further detail with reference to FIGS. 4A and 4B.

FIG. 1B depicts an operating environment of the remote user associated with the host user shown in FIG. 1A. As in the previous example, the remote user 103 of FIG. 1B operates a remote portable electronic device 104 having a front-facing image sensor 133a configured to capture a view 114a of the operating user 103, in addition to a rear-facing image sensor 133b configured to capture the view 114b of a target object or scene to share with other users. The remote portable electronic device 102 further includes a touch-sensitive display and a graphical user interface 135 for facilitating gesture input 128 from the remote user's body part 129 (e.g. finger or hand). According to one example, the remote user 101 presents the operating user that receives a workspace view relating to a target object or scene from a host operating user as will be described in further detail with reference to FIGS. 4A and 4B.

FIG. 2 is a simplified block diagram of a system implementing collaborative workspace viewing for multiple portable electronic devices according to an example of the present invention. As shown in this example embodiment, the collaborative workspace viewing system 200 includes a first portable electronic device 202 and a second portable electronic device 204 connected via a network or internetwork server 212. The first portable electronic device system 202 includes a processor 220 coupled to a display unit 210, a wireless transceiver 216, a computer-readable storage medium 225, a touch detector 217, and a front image sensor 213a and rear image sensor 213b. The touch detecting means 217 is configured to capture input 208 (e.g., finger gesture) from an operating user and may represent a three-dimensional optical sensor, a resistive touch panel, or a capacitive touch panel. The user interface 215 is displayed on the display unit 210 and provides a means for an operating user to directly manipulate graphical elements shown thereon. Moreover, display unit 210 represents an electronic visual display that when combined with the user interface 215 and the touch detection means 217, provides a touch surface user interface for enabling touch interaction between the operating user and the portable electronic device 202. In one embodiment, wireless transceiver 216 represents a radio frequency (RF) transceiver configured to receive and transmit real-time streaming data associated with the operating user and workspace. Processor 211 represents a central processing (CPU), microcontroller, microprocessor, or logic configured to execute programming instructions on the portable electronic device 202. The front image sensor 213a and the rear image sensor 213b are configured to detect and convert an optical image such as a user image 207 and shared image 206 respectively, into an electronic signal to be read the processor 211. According to one example, network server 212 represents an internetworked computing system configured to receive and transmit data to/from portable electronic device 202 and 204. Storage medium 218 represents volatile storage (e.g. random access memory), non-volatile store (e.g. hard disk drive, read-only memory, compact disc read only memory, flash storage, etc.), or combinations thereof. Furthermore, storage medium 218 includes software 219 that is executable by processor 220 and, that when executed, causes the processor 211 to perform some or all of the functionality described herein,

Similarly, the second portable electronic device includes a processor 231 coupled to a display unit 230, a wireless transceiver 236, a computer-readable storage medium 238, a touch detecting means 237, and a front image sensor 233a and rear image sensor 233b. As in the previous example, the touch detecting means 237 is configured to capture input 228 (e.g., finger gesture) from an operating user and may represent a three-dimensional optical sensor, a resistive touch panel, or a capacitive touch panel. The user interface 235 is displayed on the display unit 230 and provides a means for an operating user to directly manipulate graphical elements shown thereon. Display unit 230 represents an electronic visual display that when combined with the user interface 235 and the touch detection means 237, provides a touch surface user interface for enabling touch interaction between the operating user and the portable electronic device 204. Still further, wireless transceiver 236 represents a radio frequency (RF) transceiver configured to receive and transmit real-time streaming data associated with the operating user and workspace. Processor 231 represents a central processing (CPU), microcontroller, microprocessor, or logic configured to execute programming instructions on the portable electronic device 204. The front image sensor 233a and the rear image sensor 233b are configured to detect and convert an optical image such as a user image 227 (e.g., remote operating user) and a shared image 226 respectively, into an electronic signal to be read the processor 231. Storage medium 238 represents volatile storage (e.g. random access memory), non-volatile store (e.g. hard disk drive, read-only memory, compact disc read only memory, flash storage, etc.), or combinations thereof. Furthermore, storage medium 238 includes software 239 that is executable by processor 231 and, that when executed, causes the processor 231 to perform some or all of the functionality described herein.

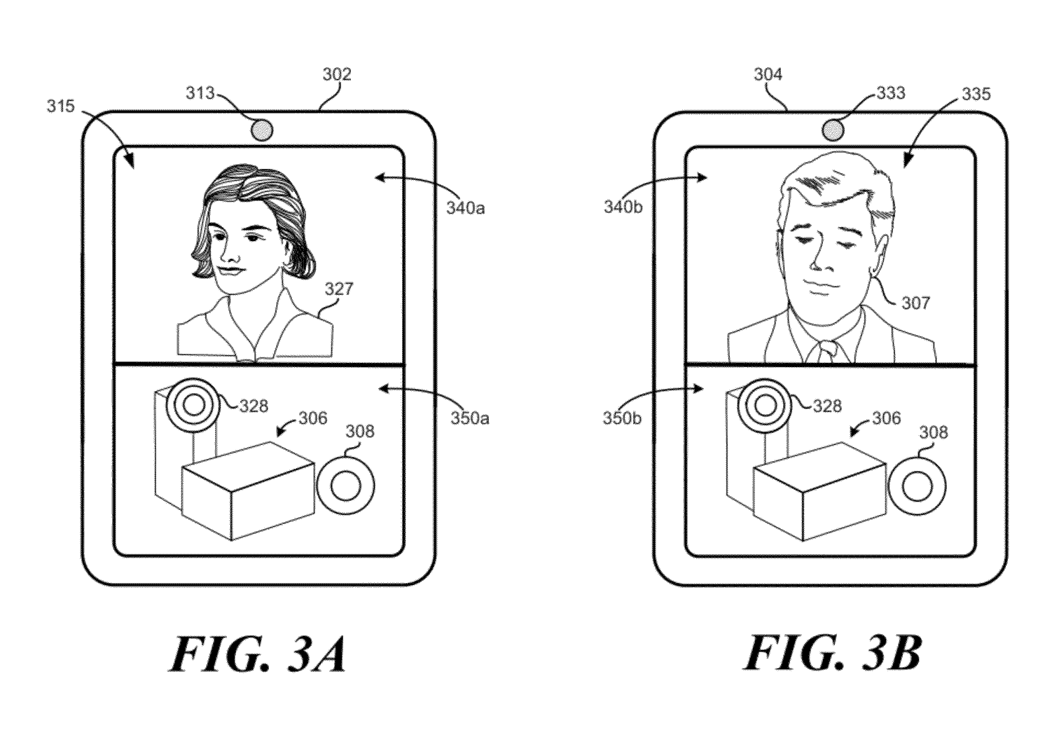

FIGS. 3A and 3B are simplified illustrations of the user interface implementing collaborative workspace viewing according to an example of the present invention. As shown in the example of FIG. 3A, a host portable electronic device 302 includes a user interface 315 for displaying graphical elements to an operating user, and a front-facing camera 313 for capturing an image of the hosting user. In accordance with one example of the present invention, the user interface 315 includes a first portion 340a for displaying a view of a user (e.g., remote user), and a second portion 350b for displaying a view of the workspace including a target object 306. More particularly, the user view 340a of the user interface associated with the host portable electronic device 302 displays a real-time image of the remote participant 327. The remote participant image 327 of the user view 340a may be located immediately below the front-facing camera 313 in order to give the operating user a better sense of eye-contact in addition to communicating to the remote user when the operating user is looking down at the workspace view 350b. The touch-sensitive user interface 315 allows the host operating user to point at part of the workspace view 350a and have the registered location of those gestures properly indicated or overlaid (e.g., concentric circular “ripples”) on the workspace view 350a. These markings or touch indicators 308 are then replicated and displayed on the workspace view 350b of the remote device 304 as shown in FIG. 3B.

Referring now to the example of FIG. 3B, a remote portable electronic device 304 also includes a user interface 335 for displaying graphical elements to an operating user, and a front-facing camera 333 for capturing an image of the remote operating user. As in the example of FIG. 3A, the user interface 335 includes a first portion 340b for displaying a view of a user (e.g., host user), and a second portion 350b for displaying a view of the workspace including the target object 306. The user view 340b of the remote portable electronic device 304 displays a real-time image of the host participant 307. The touch-sensitive user interface 335 allows the remote operating user to gesture or point at an area of the workspace view 350b and have the registered touch indicator 328 overlaid (e.g., concentric circular “ripples”) on the workspace view 350b. The markings or touch indicators 328 from the remote user are then replicated and displayed on the workspace view 350a of the host device 302 as shown in FIG. 3A.

FIG. 4 is a simplified illustration of data transfer processes using the collaborative workspace viewing method in accordance with an example of the present invention. As shown here, the collaborative workplace viewing system includes a plurality of operating users and associated devices 402a-402c. Each device 402a-402c is configured to transmit gesture data (e.g. touch indicators) 408a-408c relating to gesture input received from a respective operating user, image data 407a-407c associated with a view of the respective operating user, and rear image data 406a-406c relating to a view or target object captured by a rear-facing image sensor that is to be shared with other participating users. Furthermore, a user view 440a-440c and a workspace view 440a-440c are composited and rendered locally by the processing unit of each respective device 402a-402c. More particularly, each user view 440a-440c includes an image display of the other participating users (i.e., each user view 440a-440c will vary), while each workspace view 450a-450c includes a similar view of the shared media and any gesture interaction related thereto.

User image data 407a-407c is shared between all portable electronic devices 402a-402c in real-time in order to communicate expressions and reactions of other users within the respective user view 440a-440c. Furthermore, any of the multitude of devices 402a-402c may serve as the host device so as to share rear image data 406a-406c with the other remote participating devices. Such action serves as the basis for the workspace view 450a-450c, which is transmitted to all participating devices. Moreover, gesture data 408a-408c from all of the devices 402a-402b is processed by the processing unit with data relating to the current workspace view to produce a continually updated workspace view 450a-450c.

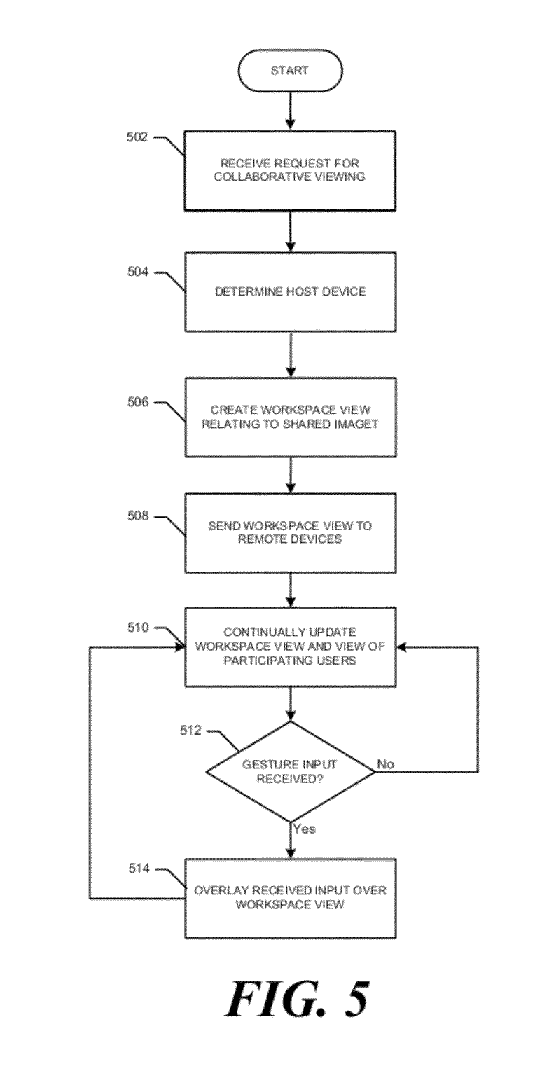

FIG. 5 is a simplified flow chart of the processing steps for providing collaborative workspace viewing according to an example of the present invention. In step 502, a portable electronic device submits a request for starting a collaborative workspace viewing session, which is received by the network server. Next, in step 504, the network server determines the host device and host user of the collaborative workspace viewing session. This may be accomplished by identifying the user who wishes to share an image view (e.g., image or video of a target object) captured by the rear-facing camera of the associated portable electronic device. A workspace view relating to the shared image is then created by the processing unit of the host portable electronic device in step 506. Thereafter, in step 508, the workspace view is transmitted to all remote participating devices for display on the respective user interface of the devices. In step 510, the workspace view and the view of the participating users (i.e., user view image captured from the front-facing camera) is continually updated on each participating device so as to provide a “live” view thereof. Upon receiving gesture input data (e.g., touch indicator) associated with an operating user of one of the portable electronic devices in step 512, then the processing unit of each portable electronic device overlays the touch indicator, or other overlay content (e.g., user draws circle around target object), on the workspace view in step 516 so as to produce a continually updated workspace view.

In sum, examples of the present invention provide for collaborative workspace viewing that combines live views of participating users with live views of a target object (e.g., via a rear facing camera of the host device) that all users may interact with such that all interactions are communicated to each participating user. Furthermore, either operating user (i.e. host or remote) may zoom or pan the workspace view in order to focus in on a particular item therein. Moreover, in order to resolve simultaneous input by multiple operating users, the system of the present examples may allow the first gesturing user to override the later gesturing user. Alternatively, the workspace views may automatically expand to accommodate the regions of the workspace view that both operating users wish to see.

Many advantages are afforded by the collaborative workspace viewing system of the present examples. For example, the collaborative workspace viewing system supports many aspects of interaction between remote participants without requiring any additional hardware beyond what is commonly available on existing portable electronic devices. In addition, providing real-time views of users and the workspace allows for immediate reaction to gesture input by participating user, thereby providing a more effective communication tool than traditional video conferencing systems.

Furthermore, while the invention has been described with respect to exemplary embodiments, one skilled in the art will recognize that numerous modifications are possible. For example, although exemplary embodiments depict a tablet personal computer as the portable electronic device, the invention is not limited thereto. For example, the portable electronic device may be a netbook, a tablet personal computer, a smartphone, or any other portable electronic device having a front and rear-facing camera.

Furthermore, in addition to capturing live video of a target object via the rear-facing image sensor, examples of the present invention may allow for collaborative workspace viewing using pre-recorded videos or images stored on an associated portable electronic device. Additionally, processing of the video feed from the rear-facing camera may include feature tracking such that the view always corresponds with a marked location or target object (or vice versa)—even when the portable electronic device and camera are slightly repositioned. Still further, the front facing camera might capture a wide-angled view image, in which case processing of the front-facing camera image data may include face detection so that only the user's facial image will be sent to other participating users. In addition, audio data relating to each operating or participating user or the target object may also be sent along with the user image data or rear image data respectively so as to create a well-integrated video conferencing environment. Thus, although the invention has been described with respect to exemplary embodiments, it will be appreciated that the invention is intended to cover all modifications and equivalents within the scope of the following claims.

What is claimed is:

1. A system for collaborative workspace viewing, the system comprising:
a first portable electronic device operated by a first user, the first portable electronic device having a display and a plurality of imaging sensors; and
a second portable electronic device operated by a second user and coupled to the first portable electronic device over a network; the second portable electronic device having a display and a plurality of imaging sensors;
wherein a shared view captured by an imaging sensor of either the first portable device or the second portable electronic device is displayed on both the first portable electronic device and the second portable electronic device, and
wherein gesture input received from both the first user and the second user and relating to the captured shared image is displayed concurrently on both the first portable electronic device and the second portable electronic device.

2. The system of claim 1, wherein the first portable electronic device includes a front-facing camera for capturing an image of the first user and a rear-facing camera for capturing a view of the shared image.

3. The system of claim 2, wherein the second portable electronic device includes a front-facing imaging sensor for capturing an image of the second user and a rear-facing imaging sensor for capturing a view of the shared image.

4. The system of claim 1, wherein the first portable device and the second portable electronic device include a touch-sensitive display for facilitating user interaction with the user interface.

5. The system of claim 1, wherein the shared image captured by the either the first portable electronic device or second portable electronic device includes a target object.

6. The system of claim 4, wherein the user interface of the first portable electronic device displays a real-time view of the second user and the shared image.

7. The system of claim 4, wherein the user interface of the second portable electronic device includes a real-time view of the first user and the shared image.

8. The system of claim 1, further comprising:
a third portable electronic device and third operating user, the third portable electronic device having a display and a plurality of imaging sensors;
wherein a shared image captured by an imaging sensor of the first portable electronic, the second portable device, or the third portable electronic is displayed on the user interface of the first portable electronic, the second portable device, and the third portable electronic, and
wherein gesture input received from the first user, second user, and third user and relating to the captured shared image is displayed concurrently on the first portable electronic, the second portable device, and the third portable electronic.

9. The system of claim 1, wherein the shared image is a prerecorded video or still image stored on the at least one portable electronic device.

10. The system of claim 4, wherein a first area of the user interface displays a user view of either the first user or second user, and a second area of the user interface displays a workspace view including the captured shared image.

11. A method for providing collaborative workspace viewing, the method comprising:
receiving a request for collaborative viewing from at least one portable electronic device of a plurality of network-connected portable electronic devices operated by a plurality of users;
creating a workspace view relating to a shared image captured from at least one portable electronic device;
displaying on a user interface associated with each of the plurality of portable electronic devices, the workspace view relating to the shared image;
overlaying gesture input received from each of the plurality of portable electronic devices on the displayed workspace view.

12. The method of claim 11, further comprising:
determining a host device and at least one remote device from the plurality of portable electronic devices.

13. The method of claim 12, wherein the step of creating a workspace view further comprises:
capturing, via the determined host device, a view of a target object from a rear-facing camera of the host device.

14. The method of claim 13, wherein the step of displaying the workspace view relating to the shared image further comprises:
transmitting the created workspace view to the at least one remote device; and
displaying, on each of the plurality of portable electronic devices, the workspace view simultaneously with a user view associated with either the host device or the at least one remote device.

15. The method of claim 14, wherein the workspace view and the user view on each of the plurality of portable electronic devices is updated and displayed in real-time.

16. A computer readable storage medium for collaborative workspace viewing, the computer-readable storage medium having stored executable instructions, that when executed by a processor, causes the processor to:
receive a request for collaborative workspace viewing from at least one portable electronic device from a plurality of network-connected portable electronic devices operated by a plurality of users;
create a workspace view relating to a sharable image captured from at least one portable electronic device;
provide for display, on a user interface associated with each of the plurality of portable electronic devices, of the workspace view on each of the plurality of ii portable electronic devices;
detect gesture input from each of the plurality of portable electronic devices; and
provide for display, on the user interface associated with each of the plurality of portable electronic devices, of the gesture input from each portable electronic device over the workspace view.

17. The computer readable storage medium of claim 16, wherein the executable instructions further cause the processor to:
determine a host device and at least one remote device from the plurality of portable electronic devices.

18. The computer readable storage medium of claim 17, wherein the executable instructions for creating a workspace view further cause the processor to:
capture a target object from a rear-facing camera associated with the determined host device.

19. The computer readable storage medium of claim 18, wherein the executable instructions for displaying the workspace view relating to the target object further cause the processor:
transmit the created workspace view to the at least one remote device; and
display the workspace view simultaneously with a user view associated with either the host device or the at least one remote device.

20. The method of claim 19, wherein the workspace view and the user view are displayed on each of the plurality of portable electronic devices in real-time.
